(19) United States
(12) Patent Application Publication
(10) Pub. No.: US 2005/0007664 A1
(43) Pub. Date: Jan. 13, 2005

(54) Lenticular lens for display

(76) Inventors: Ellis D. Harris, Claremont, CA (US); Scott M. Stratford, Alta Loma, CA (US)

Correspondence Address: Ellis D. Harris, 1646 Lynoak Dr., Claremont, CA, 91711, US

(21) Appl. No.: 10/613,307

(22) Filed: Jul. 7, 2003

(51) Int. Cl. G03B 21/60

(52) U.S. Cl. 359/456

(57) ABSTRACT

Lenticular lenses in a monolithic array, wherein each individual lens element is similar to an immersion lens and integrated one-to-one with total-internal-reflecting light pipes that correspond to individual pixels. Each lens and lightpipe element in the display array collects optical flux from a corresponding pixel while reducing or eliminating optical flux cross-feed between adjacent pixels and projects the flux into an expanded field of view. With a reflective or non-self luminous display device, a large field of view is achieved for the collection of ambient illumination and for viewing the display. Each lens element concentrates and focuses ambient illumination upon one corresponding reflective pixel whereupon the pixel's color is read in the reflected light The light pipe enhances collection of ambient light illumination, display brightness and display field of view. The inventive lens/lightpipe combination will additionally benefit other applications of a “Cats Eye” type retro-reflector.

### CROSS-REFERENCE TO RELATED PATENTS

This invention contains subject matter that relates to subject matter in U.S. Pat. No. 6,222,519 entitled “ROLLER OPTICAL GATE DISPLAY DEVICE”, assigned to the same assignee and herein incorporated by reference.

### BACKGROUND OF THE INVENTION

This invention relates to a visual display method and device that improves the viewability of many display technologies including but not limited to LCD, LED, OLED, FED, plasma and chromatophore. Such display technologies often use sub-pixel elements which in aggregate create a single pixel of a certain color value. For example, a LCD display has three different color liquid crystals (red, green, blue) grouped as a single pixel. In a chromatophoric display one or more chromatophore elements can also be used as sub-pixels to form a single pixel. This invention improves visibility by collecting optical flux from individual pixels without crossover from adjacent pixels and keeping said flux of individual pixels separate until it is dispersed in a way to improve the field of view.

This invention is especially relevant to reflective displays that are not self-illuminated and depend on ambient lighting for viewability, and more particularly to a lenticular lens for utilization with a display device utilizing colored beads on a string. The following explanations will explain how the invention can be used with a reflective chromatophoric-style display device as described in U.S. Pat. No. 6,222,519 entitled “ROLLER OPTICAL GATE DISPLAY DEVICE”. However it should be noted that the invention can be used with any pixel-based display technology whether they are self-luminous or ambient-light reflective.

U.S. Pat. No. 6,222,519 entitled “ROLLER OPTICAL GATE DISPLAY DEVICE” describes a visual display device comprised of a plurality of multicolored hollow beads on a plurality strings wherein the beads comprise a two-dimensional array. Bead surfaces are colored by a plurality of color stripes parallel to bead axis. Rotation of beads by electromagnetic means allows the two-dimensional bead array to display a visual image. Bead color for display is selected by rotating the bead by an image signal to the position to show the desired color. A selected color segment on a bead becomes a pixel of an image that is to be displayed. Being non-self luminous but depending upon ambient illumination these pixels have much in common with chromatophores found in certain animal species.

When one of the color stripes on a bead is being displayed it is needful to collect flux from that stripe and disperse it into a reasonable field of view as a pixel of an image. It is also needful to block flux from adjacent beads that would confuse the pixel. An additional need is that the field of view of the display be maximized. The lenticular lens herein described provides these functions.

The beads-on-a-string display device is not self-luminous but utilizes ambient illumination. As such the display offers enhanced power efficiency providing a particular benefit in battery powered portable equipments since battery power is not needed to generate a luminous display. An additional benefit of the non-luminous is visibility under bright ambient conditions such as direct sunlight.

In its preferred configuration the present invention comprises an integrated lens/lightpipe array in a monolithic structure. Ambient illumination is collected, concentrated and focused onto selected color stripes on an array of beads-on-a-string. Color selection is achieved by rotating beads to one of a number of possible positions as determined by an image that is to be displayed. Optical flux is reflected by a colored stripe and returned to a lens, retracing its input path.

The integral light pipe provides a path to include ambient flux from a broader field of view than otherwise possible. By means of total internal reflection at the air/medium interface at lightpipe surfaces flux that otherwise would be focused at positions other than on the desired bead stripe is redirected to the given color stripe. In particular ambient flux at large off axis angles will be collected and focused upon given color stripes.

Upon reflection optical flux is returned back upon its input path and refracted by the lens into the collection field of view. Utilization of lightpipes benefits display brightness in two ways. Firstly, ambient illumination is collected from a wider field of view than otherwise. Secondly, the light pipe redirects flux that is reflected into a solid angle exceeding that subtended by the lens, redirecting it onto the lens. In absence of the lightpipe all flux reflected into a solid angle not included in that subtended by the lens could not contribute to display brightness but would need to be eliminated to avoid pixel confusion.

Each element of the lenticular array is comprised of a lens similar to that commonly utilizes in an oil-immersion microscope lens, the immersion medium being common with the lens and is also the medium of the lightpipe. The lightpipe additionally serves to provide optical isolation between adjacent lens elements as a result of the air space between adjacent light pipes, the air space serving as a baffle.

Lens elements of the array tile-the-plane of the lenticular lens front surface. That is the lens elements provide continuous coverage over this plane with little or no gaps. Cross sections of the integral light pipes are smaller than a lens element surface and adjacent lightpipes are bridged the thickness dimension of the lenses. Flux reflected by a bead stripe that misses the lens surface but passes through the bridge will impact an adjacent lens surface. In the preferred embodiment such flux will impact the adjacent lens at an angel wherein it is completely reflected by total internal reflection.

Lenticular lens arrays are well known and a number of patents have been issued recently. None of these, however, provide the benefits and functions of the present invention. Included in these prior art patents are: U.S. Pat. No. 6,049,423 “Rear Projection Screen . . . ; U.S. Pat. No. 6,101,031 “Lenticular Lens Sheet . . . ; U.S. Pat. No. 6,130,777 “Lenticular Lens Sheet With a base sheet . . . ; WO 00/779,340 A1 “Projection Screen with a Lenticular . . . ; U.S. Pat. No. 6,169,633 B1 “Lenticular Lens Sheet and Transmission Type . . . ; and many others, including:

| | | |
|---|---|---|
| 5,216,543 | 5,933,228 | 5,101,279 |
| 5,505,804 | 5,592,332 | 5,999,685 |
| 6,132,652. | | |

There is no conflict between any of these prior art patents and the present invention.

It is an object of this invention to provide a lens for the collection and transmission of optical flux from individual pixels with minimal loss. and project said flux into an improved and observable field of view.

It is an additional object of this invention to reduce or eliminate reflection cross talk of optical flux between adjacent pixels while the optical flux is being collected and transmitted by the lens.

It is an object of this invention to provide collection of ambient illumination, concentrate the collected flux upon pixels of a non-self luminous display device and project flux reflected from the pixels into an observable field of view.

It is a further object of this invention to provide a plurality of lenticular lenses in an array wherein each lens element provides a large field of view for the projection of the color of a selected single pixel while significantly blocking adjacent pixels from an observer's field of view.

It is still an additional object of this invention to provide a bright, wide field of view for a “cats-eye” type retro-reflector.

Other attainments, together with a more complete understanding of the invention will become apparent and be more fully appreciated by reference to the following description and claims taken in conjunction with the accompanying drawings.

### SUMMARY OF THE INVENTION

Lenticular lenses in a monolithic array, wherein each individual lens element is similar to an immersion lens sand integrated one-to-one with total-internal-reflecting light pipes that correspond to individual pixels. Each lens and lightpipe element in the display array collects optical flux from a corresponding pixel while reducing or eliminating optical flux cross-feed between adjacent pixels and projects the flux into an expanded field of view. With a reflective or non-self luminous display device, a large field of view is achieved for the collection of ambient illumination and for viewing the display. Each lens element concentrates and focuses ambient illumination upon one corresponding reflective pixel whereupon the pixel's color is read in the reflected light. The light pipe enhances collection of ambient light illumination, display brightness and display field of view. The inventive lens/lightpipe combination will additionally benefit other applications of a “Cats Eye” type retro-reflector.

### BRIEF DESCRIPTION OF THE DRAWINGS

FIG. 1 illustrates a cross-section of a monolithic lenticular lens/lightpipe array made in accordance with the present invention.

FIG. 2 illustrates an embodiment of the invention wherein lens surfaces at the ends of light pipes are cylindrical, closely matching the adjacent surface of a single-bead chromatophoric pixel utilizing cylindrical beads as a roller optical gate.

FIG. 3 illustrates utilization of the invention in a retro-reflection application wherein the surface at the focal point is reflective.

### DESCRIPTION OF THE PREFERRED EMBODIMENT

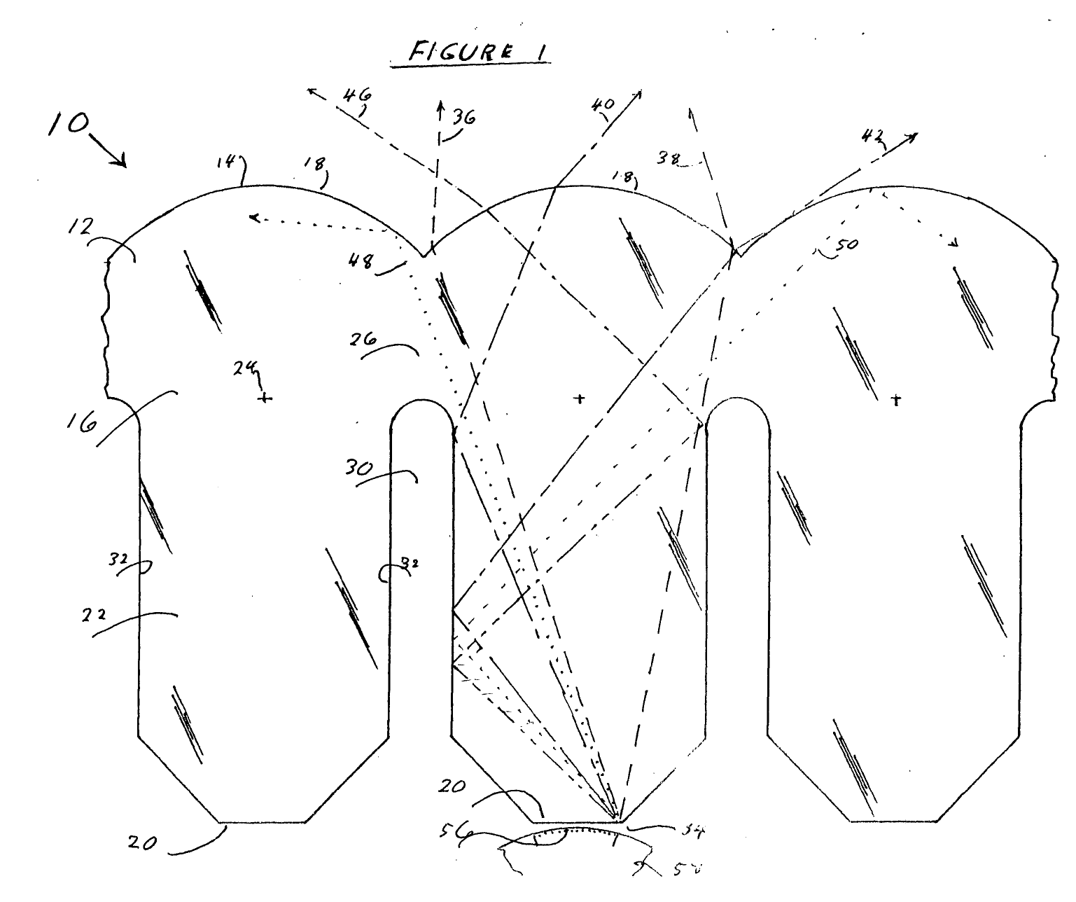

Reference is now made to FIG. 1 wherein is illustrated a lenticular lens array 10 in accordance with the present invention. Substrate 12 is optionally comprised of any of a number of optical materials, including glass and plastic. Array 10 is comprised of a plurality of at least one lens element 14 immersed in a material 16 of matching optical index. Each element of array 10 is comprised of a lens front surface 18, a rear surface 20 and a total-internal-reflecting light pipe 22 comprised of the intervening optical medium bounded by reflecting walls 32.

FIG. 1 serves to illustrate two embodiments of the invention. In a first embodiment surface 18 is cylindrical, having a cylindrical axis into the page of the drawing and each light pipe 22 is comprised of an integral wall that also extends into the page and terminates in rear surface 20 that also extends the length of the array into the page.

In a second embodiment, also illustrated by FIG. 1, each lens element first surface 18 is spherical and each integral light pipe 22 is a circular rod. In this embodiment FIG. 1 represents the cross section in each of the two orthogonal directions.

In either of the two embodiments the cross section shape of lens surface 18 may be circular centered at its center, point 24, or it may optionally be comprised of the section a more complex shape such as typified by an aspheric lens element.

While light pipes 22 are illustrated with sides parallel to lens axis it is to be understood that a slight draft angle may be included for any of a number of reasons, including to facilitate fabrication.

Each lens element 14 is immersed in the medium of which it is fabricated and of common refractive index. It is well known that for a lens element immersed in an index-matching medium the lens focal length within the medium, either spherical or cylindrical, is determined from the radius of curvature R and refractive index N by the following relation:
F=R/[1−1/N] (1)

Exit surface 20 at the far end of lens element 14 is located in the approximate position this focal point, centered on the optical axis and on the bead stripe, and is as close to the bead surface as practical. In either the cylindrical or spherical lens each lens element 14 is connected to an adjacent element 14 by bridge 26, providing a monolithic structure for the array.

Light pipes 22 are separated by spaces 30 and light pipe total-internal-reflecting surfaces 32 are optically smooth wherein they function as total internal reflectors for light rays when the angle of incidence exceeds a critical value given by:
Critical angle=arc sin(1/N) (2)

Lens/lightpipe function is described herein in terms of optical output rays that originate at an extreme point 34 on rear surface 20 and emerge from the lens at surface 18. Ambient light collection will follow similar ray paths on the input path. Rays 36 and 38 impinge upon lens surface 18 without first being reflected by sides 32 of light pipe 22. These rays are nearly collimated as they emerge from surface 18, differing from collimation only by spherical aberration effects. Taken together rays 36 and 38 represent extreme rays of that fan of rays that are not reflected by a surface 32 of light pipe 22 and illustrate the extreme of the field of view of reflected rays that impinge directly upon lens surface 18 without being reflected by the lightpipe.

Rays 40 and 42 illustrate a pair of rays that have been reflected once at a light pipe surface. These two rays represent limits of that fan of rays having a single reflection at a light pipe surface, impact the correct lens surface 18 and hence are refracted into the display field of view. These rays, 40 and 42, impinge upon lens surface 18 at appreciable angles of incidence but less than the critical angle. Refraction at surface 18 further spreads these rays and the ray fan they represent is projected into a large field of view.

Ray 46 is typical of rays that make two reflections at light pipe surfaces. Such rays also spread flux reflected by a bead color stripe into a large field of view.

Rays 46 and 42 illustrate effective field of view of ambient illumination collection and also for the displays. These rays, along with reflected rays originating over the bead color stripe 56 illustrate that the lens aperture is filled with optical flux. The inventive lens/lightpipe is thus seen to stitch bead color segments 56 (pixels) seamlessly over the lenticular lens aperture.

Rays 48 and 50 illustrate rays that miss the output surface 18 of the appropriate lens and also miss the walls of light pipe 22. These rays pass through optical bridge 26 and impact surface 18 of an adjacent lens element. Their angle of incidence at the adjacent lens surface exceeds the critical angle; they are totally reflected at the surface thus being prevented from contributing undesirable color to an adjacent lens. As seen from FIG. 1 rays 38 and 46 bound the bridge 26 region. Rays typified by rays 48 and 50 transit bridge region 26 and would contribute unwanted color in an adjacent lens area unless eliminated as they are by reflection at surfaces 18 of the adjacent lens. Lightpipes 22 are separated by air spaces 30 that serve as baffles by redirecting rays that otherwise would impact wrong lens elements 18.

The above related functions result directly from inclusion of light pipe 22, without which many reflected rays could not be collected or, if collected, would result in cross talk between colors of adjacent beads. While only rays proceeding from a single point 34 on rear surface 22 have been described it is apparent that rays from other points on surface 22 will follow similar paths.

FIG. 2 illustrates a modification 50 of light pipe rear surface whereby the lightpipe rear surface 52 is curved to closely match the bead curvature surface 54. By this means light from adjacent strips on a bead are better excluded from the field of view. Additional exclusion can be achieved by making surface 52 or 20 smaller than the width of a color stripe 56 on the bead.

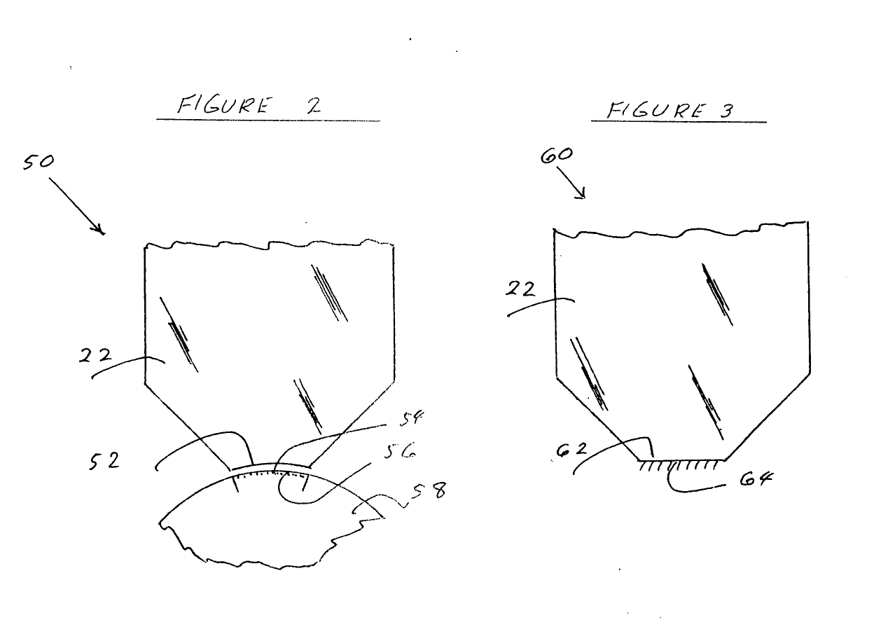

FIG. 3 illustrates the invention 60 when utilized in a retro-reflection mode. In this application lightpipe rear surface 62 is comprised of reflecting surface 64 that can, optionally, be diffuse or specular. Incident flux originating from an external point source within the field of view and entering lens surface 18, not shown in FIG. 3, will be focused upon reflecting surface 64. Reflected flux will nominally be returned back upon along the entrance light path. The presence of lightpipe 22 enhances both collection efficiency and field of view of the resultant retro-reflector. Retro reflector field of view is the field of view of collected ambient illumination as described in connection with FIG. 1.

While the invention has been described in conjunction with specific embodiment, it will be evident to those skilled in the art that many alternatives, modification and variations will be apparent in light of the foregoing description. Accordingly the invention is intended to embrace all such alternatives, modifications and variations as fall within the spirit and scope of the appended claims.

1. A display method to collect and project optical flux from an array of at least one display pixels wherein:
each said display pixel can be controlled to produce optical flux of variable colors or values;
optical flux of said display pixels is collected into at least one of a plurality of light pipes;
each light pipe is associated with one at least one of a plurality of lens elements;
and, at the exit of each light pipe said at least one lens elements direct said optical flux to a desired field of view.

2. The method of claim 1 wherein said lens elements and said light pipes are integrated and are comprised of common optical medium:

3. The method of claim 2 wherein said lightpipe is achieved as a result of total internal reflection at a high-index: low-index interface along the sides of said lightpipe and wherein said low-index medium is typified by air.

4. The method of claim 2 wherein lens focal length to said elemental lens is expressed, at least approximately as:
F=R/(1−1/N),
where R is the lens surface radius of curvature and
where N is the refractive index of said common medium.

5. The method of claim 2 wherein said lens surface is aspheric and wherein said radius R is the effective radius of a limited region near apex of said aspheric lens.

6. The method of claim 2 wherein optical flux that enters the end of said lightpipe from a said display pixel passes through said high-index medium either by a direct path or by a reflection path to the refracting surface of said lens element whereupon said flux is dispersed over a solid angle.

7. Apparatus comprised of an array of one or more display elements Wherein each display element is comprised of at least one of a plurality of lightpipes and at least one of a plurality of lens elements whereby optical flux emanating from at least one of a plurality of pixels is collected and projected into a visual field for display.

8. The apparatus of claim 7 wherein image-wise data presented by said plurality of pixels is projected into a visual display field.

9. The apparatus of claim 7 wherein said lightpipes and lens elements comprise an integrated, monolithic unit.

10. The apparatus of claim 8 wherein said lightpipes and said lens elements are comprised of common optical material.

11. The apparatus of claim 8 wherein total internal reflection of flux at the lightpipe air-medium interface serves to collect at least a portion of flux emanating from pixels that would not directly intercept the refracting surface of an associated lens element whereby said portion is redirected to the refracting surface of said lens elements and thereby included in displayed flux.

12. The apparatus of claim 11 wherein two or more integrated lens/lightpipe units are joined to comprise a monolithic array and wherein the total internal reflecting surfaces of adjacent light pipes within said apparatus remain separated by regions of low-index medium.

13. The apparatus of claim 12 wherein at least a portion of optical flux that does not directly intercept the lens refracting surface and that also is not redirected by a surface of said light pipe but intercepts an adjoining lens element impacts said adjoining lens element at an angle whereby total internal reflection occurs whereby said flux is prevented from passing said adjoining lens element.

14. The apparatus of claim 7 wherein said lens elements are comprised of spherical segments and wherein said lightpipes are cylindrical having an axis approximately parallel to the axis of said lens.

15. The apparatus of claim 7 wherein said lens elements are comprised of cylindrical segments and wherein said lightpipes have an extent along the length of said cylindrical lenses whereby flux emanating from line of pixels is collected and projected for display.

16. The apparatus of claim 12 wherein lens surfaces of said monolithic array at least approximately completely tile-the-plane of the array.

17. The apparatus of claim 16 whereby flux emanating from a pixel of extent smaller than the lens surface at least approximately fills the surface of said lens.
